(19) United States
(12) Patent Application Publication
(10) Pub. No.: US 2011/0139304 A1
(43) Pub. Date: Jun. 16, 2011

(54) ICE GUIDE FUNNEL

(75) Inventors: KEVIN M. CHASE, SAINT JOSEPH, MI (US); TONY L. KOENIGSKNECHT, AUSTIN, TX (US); JEROLD M. VISIN, BENTON HARBOR, MI (US)

(73) Assignee: WHIRLPOOL CORPORATION, BENTON HARBOR, MI (US)

(21) Appl. No.: 12/636,988

(22) Filed: Dec. 14, 2009

(51) Int. Cl. B67C 11/04; B67D 7/80; F25C 5/18; B67C 11/00

(52) U.S. Cl. 141/331; 222/146.6; 62/344; 222/462

(57) ABSTRACT

An appliance dispenser includes a housing defining a recess. The housing includes a receptacle support member and a fixed funnel. An ice dispensing passage extends through the fixed funnel and operably connected with an ice bin. A variable funnel includes a proximal end and a distal end. The proximal end is adjacent the fixed funnel. The distal end is movable between a retracted position and an extended position.

### BACKGROUND OF THE PRESENT INVENTION

The present invention generally relates to an ice guide-funnel, and more specifically, to an ice guide funnel operable between retracted and extended positions.

### SUMMARY OF THE INVENTION

In one aspect of the present invention, an appliance dispenser includes a housing defining a recess. The housing includes a receptacle support member and a fixed funnel. An ice dispensing passage extends through the fixed funnel and operably connects with an ice bin. The appliance dispenser also includes a variable funnel that includes a proximal end and a distal end. The proximal end is adjacent the fixed funnel. The distal end is movable between a retracted position and an extended position.

In another aspect of the present invention, an appliance includes an ice bin. A dispenser is adjacent to the ice bin and includes a fixed funnel that extends from the dispenser. The dispenser also includes an extendable funnel that is adjacent to the fixed funnel and adapted to be extended to a first position and retracted to a second position. An ice dispensing passage extends from the ice maker through the fixed funnel and extendable funnel. The ice dispensing passage lengthens when the extendable funnel moves from the first position to the second position.

In yet another aspect of the present invention, a dispenser for use on an appliance includes a housing defining a recess. The housing includes a receptacle support member and a first funnel. An ice dispensing passage extends through the first funnel and into operable connection with an ice maker. A second funnel includes a distal end and is operable between an extended position and a retracted position. The distal end of the second funnel is closer to the first funnel when in the retracted position then when in the extended position.

These and other features, advantages, and objects of the present invention will be further understood and appreciated by those skilled in the art upon studying the following specification, claims, and appended drawings.

### BRIEF DESCRIPTION OF THE DRAWINGS

FIG. 1 is a front elevational view of a refrigerator incorporating one embodiment of an ice guide funnel of the present invention;

FIG. 2 is the refrigerator of FIG. 1 with a freezer side door open;

FIG. 3 is a top perspective exploded view of one embodiment of the ice guide funnel;

FIG. 4 is a top perspective view of a portion of the ice guide funnel in a retracted position;

FIG. 5 is a front elevational view of the funnel portion of FIG. 4;

FIG. 6 is a top plan view of the funnel portion of FIG. 4;

FIG. 7 is a side cross-sectional view of the funnel portion of FIG. 4;

FIG. 8 is a top perspective view of a portion of one embodiment of the funnel in an extended position;

FIG. 9 is a front elevational view of the funnel portion of FIG. 8;

FIG. 10 is a top plan view of the funnel portion of FIG. 8;

FIG. 11 is a side cross-sectional view of the funnel portion of FIG. 8;

FIG. 12 is a top perspective view of one embodiment of an ice guide funnel of the present invention;

FIG. 13 is a front elevational view of the ice guide funnel of FIG. 12;

FIG. 14 is a top perspective view of the ice guide funnel of FIG. 12 with a portion of the funnel in an extended position;

FIG. 15 is a front elevational view of the ice guide funnel of FIG. 14;

FIG. 16 is a top perspective view of the ice guide funnel installed in an ice dispensing apparatus of a refrigerator;

FIG. 17 is a front elevational view of the ice guide funnel installed, as shown in FIG. 16;

FIG. 18 is a front elevational view of a cup placed underneath the ice guide funnel;

FIG. 19 is a front elevational view of the cup in position to receive ice and with a portion of the ice guide funnel in the extended position;

FIG. 20 is a side cross-sectional view of one embodiment of a vertical ice chute of the present invention;

FIG. 21 is a front elevational view of a cup receiving ice from a vertical ice chute; and

FIG. 22 is a side cross-sectional view of the cup receiving ice from the vertical ice chute.

### DETAILED DESCRIPTION OF EMBODIMENTS

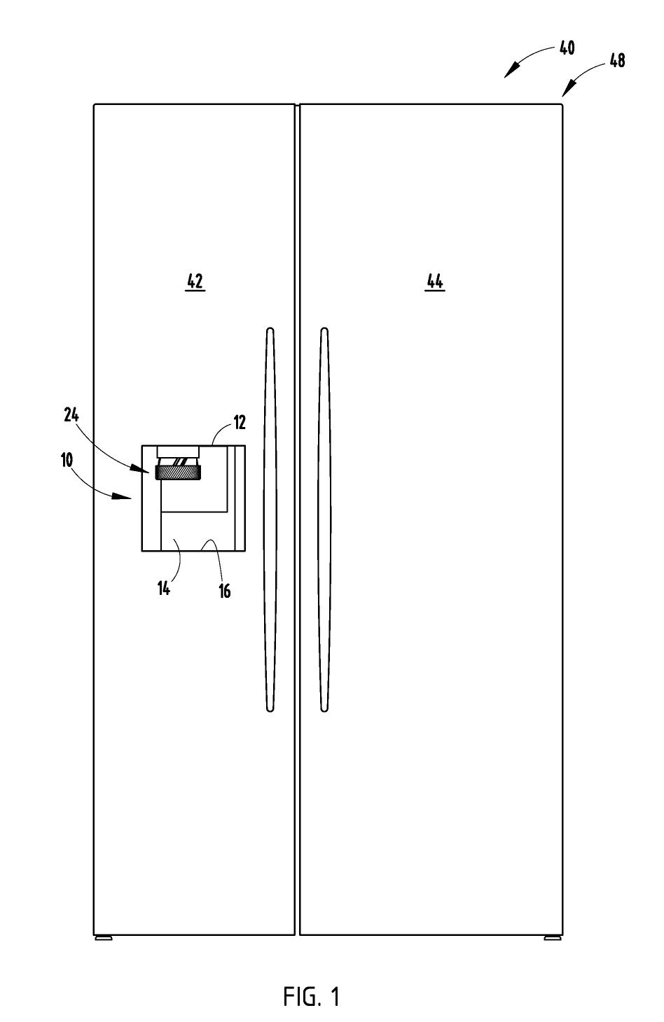

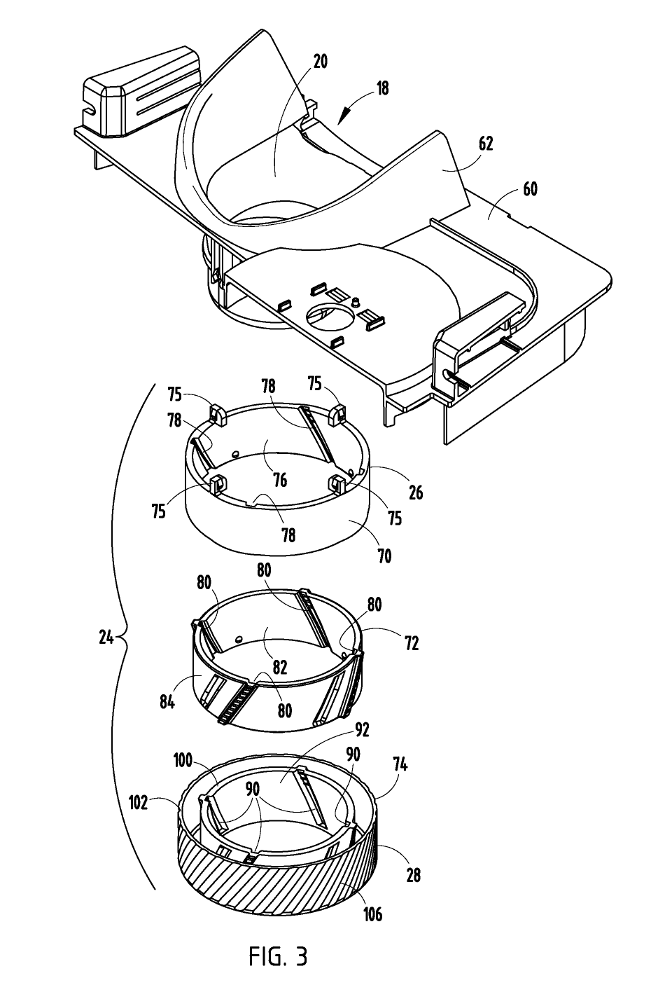

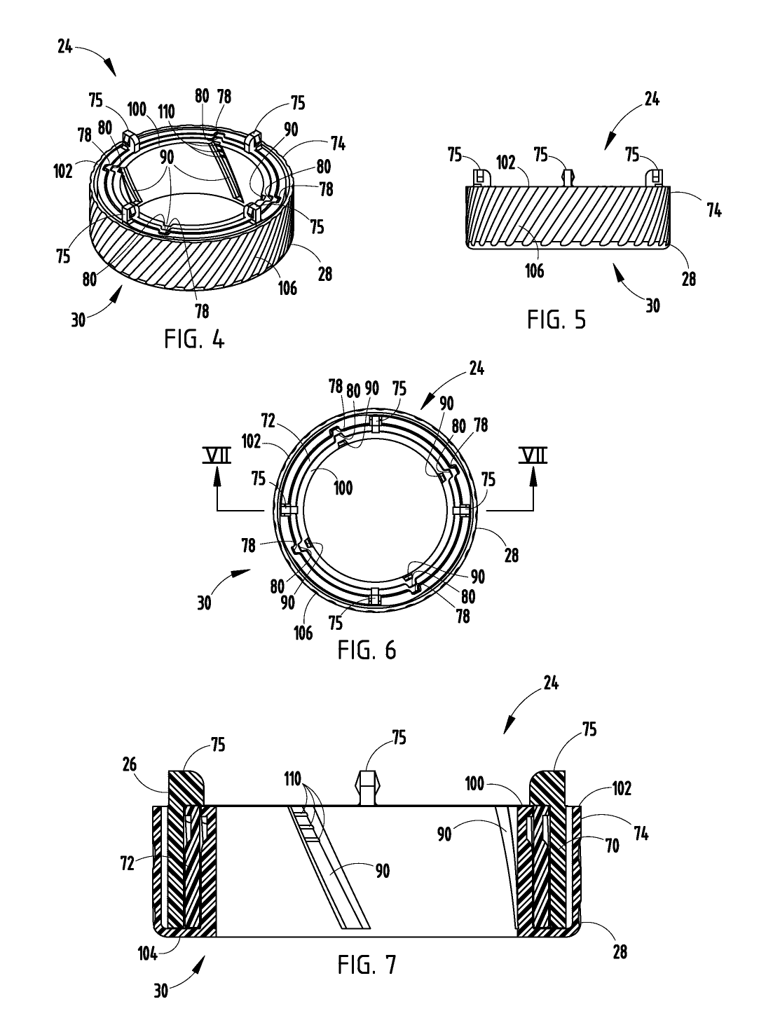

For purposes of description herein the terms “upper,” “lower,” “right,” “left,” “rear,” “front,” “vertical,” “horizontal,” and derivatives thereof shall relate to the invention as oriented in FIGS. 1 and 3. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

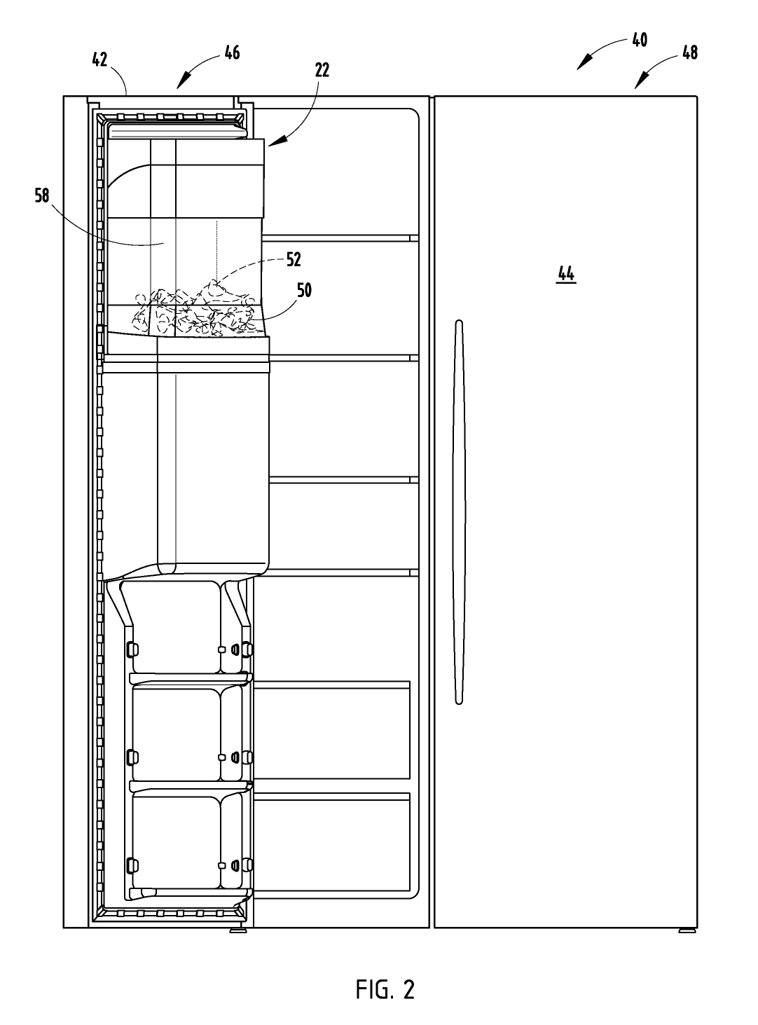

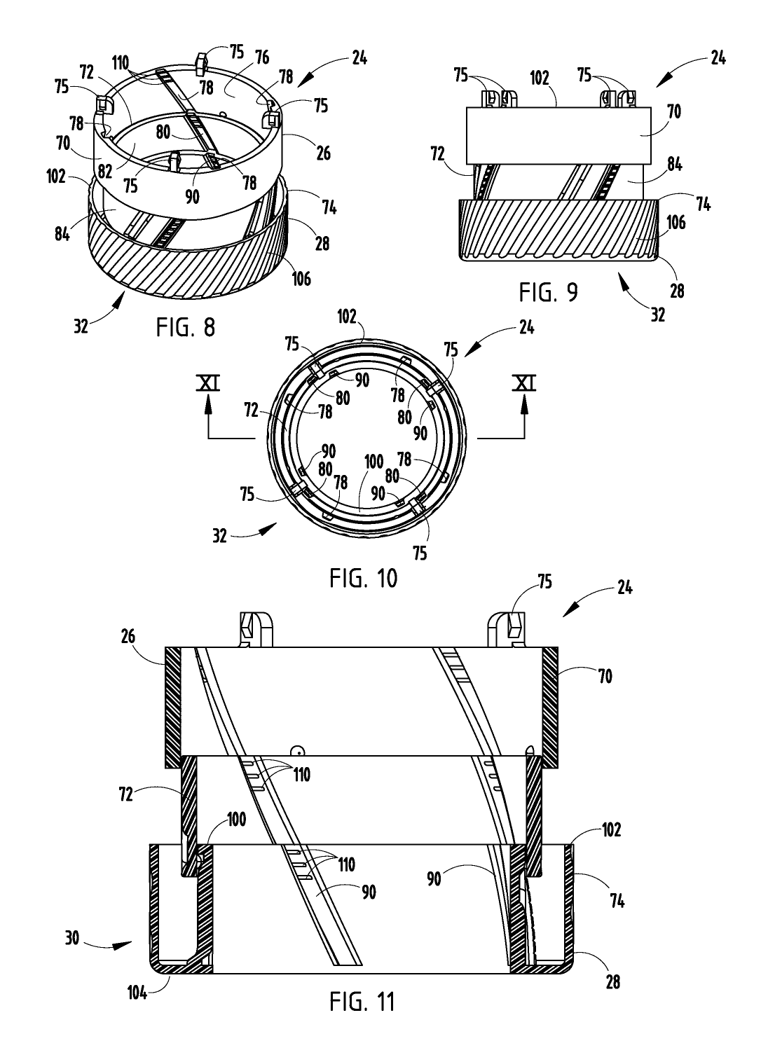

Referring to the embodiment illustrated in FIGS. 1-3, the reference numeral 10 generally designates an appliance dispenser having a housing 12 defining a recess 14. The housing 12 includes a receptacle support 16 and a fixed funnel 18. An ice dispensing passage 20 extends through the fixed funnel 18 and is operably connected with an ice maker 22. A variable funnel 24 includes a proximal end 26 and a distal end 28. The proximal end 26 is adjacent the fixed funnel 18. The distal end 28 is movable between a retracted position 30 (FIG. 4) and an extended position 32 (FIG. 8).

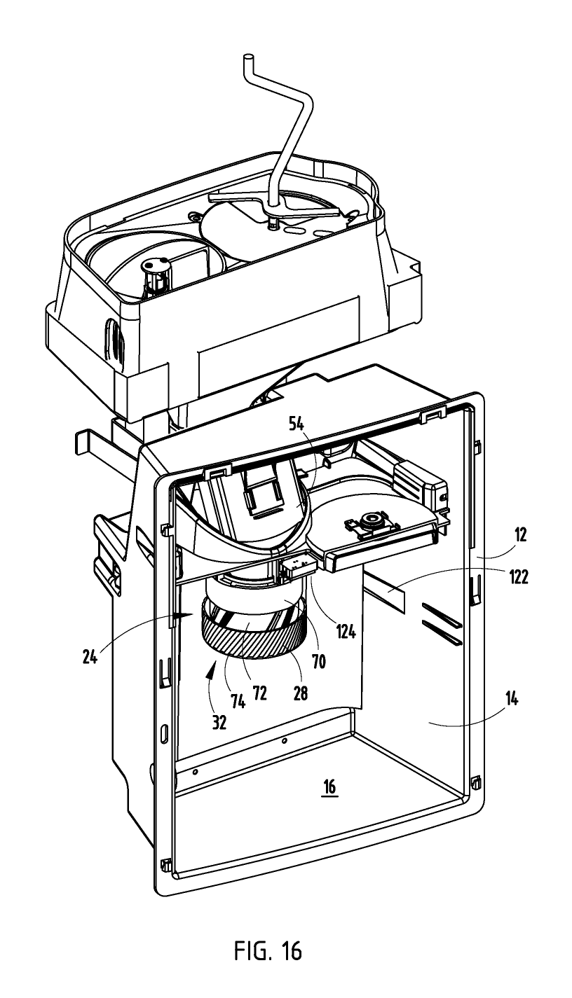

Referring again to FIGS. 1-3, the appliance dispenser 10 is generally installed in an appliance, such as a refrigerator 40 (FIG. 1). The refrigerator 40 includes first and second doors 42, 44 operable between open and closed positions 46, 48, which keep contents disposed in the refrigerator 40 in a refrigerated or frozen state. An ice bin 50 is disposed inside the refrigerator 40, the contents of which are accessible from inside the refrigerator 40, or from outside the refrigerator 40 through the appliance dispenser 10. To actuate the dispenser 10 and access ice 52 from outside the refrigerator 40, a trap door 54 (FIG. 16) disposed below the dispenser 10 is opened. The dispenser 10 is positioned below an ice storage unit 58 and, when the trap door 54 opens, ice flows to the fixed funnel 18. When ice 52 reaches the fixed funnel 18, the ice 52 descends through the ice dispensing passage 20 in the fixed funnel 18 and though the variable funnel 24, at which point the ice 52 is dispensed from the refrigerator 40.

Referring to FIGS. 3 and 12-15, the fixed funnel 18 includes a base 60 with an upwardly collection wall 62 that extends around the ice dispensing passage 20 defined by the fixed funnel 18. The collection wall 62 is designed to guide ice 52 down into the ice dispensing passage 20 and into the variable funnel 24. The fixed funnel 18 is secured to the housing 12 that is disposed in one of the first and second appliance doors 42, 44.

Referring again to the embodiment illustrated in FIG. 3, the variable funnel 24 includes a top annular ring 70, an intermediate annular ring 72, and a bottom annular ring 74. The top annular ring 70 is proximate with and connected to the fixed funnel 18 and does not generally move relative to the fixed funnel 18. The top annular ring 70 includes a plurality of engagement tabs 75 that secure the top annular ring 70 to the fixed funnel 18. An inner circumferential area 76 of the top ring 70 includes a plurality of threads 78 adapted to engage the intermediate annular ring 72, as discussed in more detail below. The threads 78 may be vertically aligned or may be angled (as shown in FIG. 3). The threads 78 allow for vertical translation of the intermediate annular ring 72 relative to the top annular ring 70.

Referring again to the embodiment illustrated in FIG. 3, the intermediate annular ring 72 includes a plurality of threads 80 disposed both on an inner circumferential area 82 of the intermediate annular ring 72 and an outer circumferential area 84 of the intermediate annular ring 72. The threads 80 on the outer circumferential area 84 of the intermediate annular ring 72 slidably engage the threads 78 disposed on the inner circumferential area 76 of the top annular ring 70, which allows for the intermediate annular ring 72 to slide upward and downward relative to the top annular ring 70. The threads 80 disposed on the inner circumferential area 82 of the intermediate annular ring 72 are designed to engage threads 90 disposed on another circumferential area 92 of the bottom annular ring 74. Specifically, the threads 90 disposed on the outer circumferential area 92 of the bottom annular ring 74 slidably engage the threads 80 disposed on the inner circumferential area 82 of the intermediate annular ring 72, allowing for vertical translation of the bottom annular ring 74.

Referring again to the embodiment illustrated in FIG. 3, the bottom annular ring 74 includes an inner portion 100 and an outer portion 102 connected by a bottom wall 104 (FIG. 7). The outer portion 102 is larger than both the intermediate annular ring 72 and the top annular ring 70, and is designed to cover each of the three rings 70, 72, 74 when the variable funnel 24 is in the retracted position 30 (FIG. 4). The outer portion 102 also includes a gripping surface 106 that allows a user to grab the outer portion 102 and pull the outer portion 102 downward in a vertical direction. Depending on the orientation of the threads 78, 80 and 90, it is contemplated that the bottom annular ring 74 may descend linearly relative to the top annular ring 70 or may spiral downward relative to the top annular ring 70. The threads 90 are located on the inner portion 100 and slidably engage the threads 80 of the intermediate annular ring 72. The threads 78, 80, 90 include protrusions 110 (FIG. 7) that frictionally engage to keep the rings 70, 72, 74 of the variable funnel 24 at the retracted position 30 (FIG. 4), extended position 32 (FIG. 8), or a predetermined position therebetween.

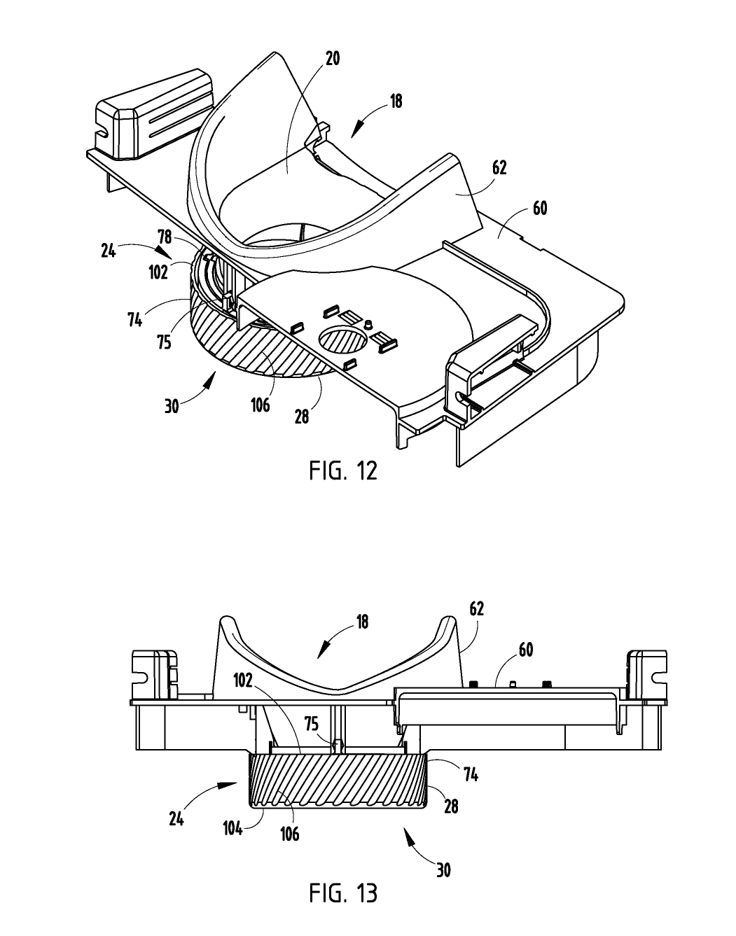

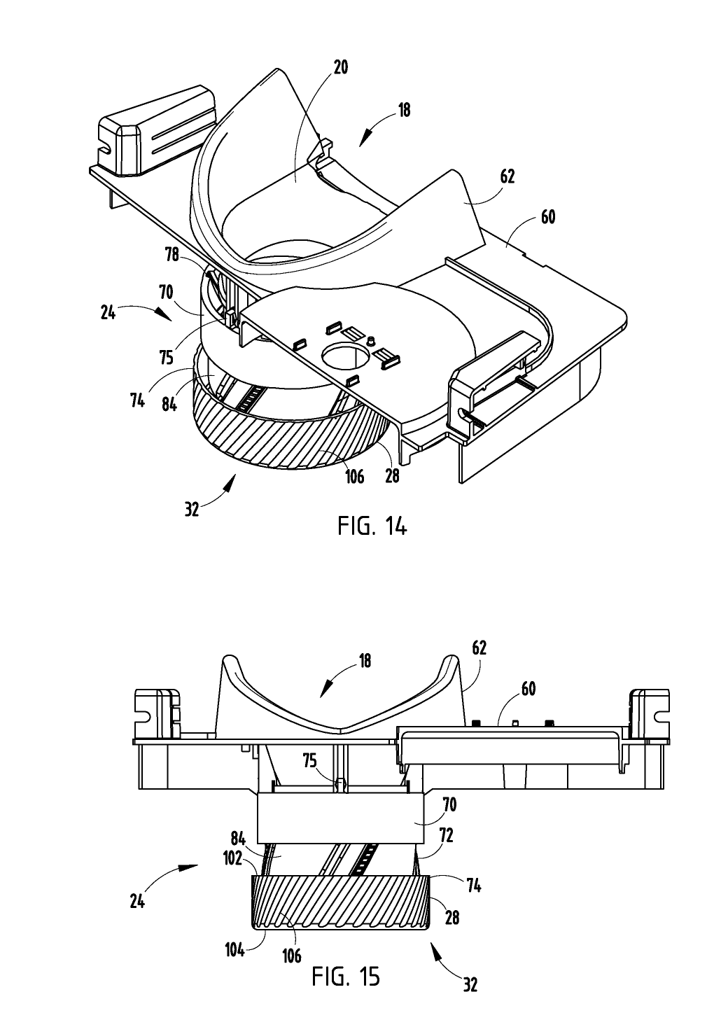

Referring now to FIGS. 12-15, the outer portion 102 of the bottom annular ring 74 is positionable over both the intermediate annular ring and the top annular ring when the variable funnel 24 is in the retracted position 30. When in the extended position 32 (FIGS. 14 and 15), each of the top annular ring 70, intermediate annular ring 72, and bottom annular ring 74 are at least partially exposed. As the funnel lengthens, the likelihood of splashing as a result of ice dispensing minimizes due to a more controlled ice drop.

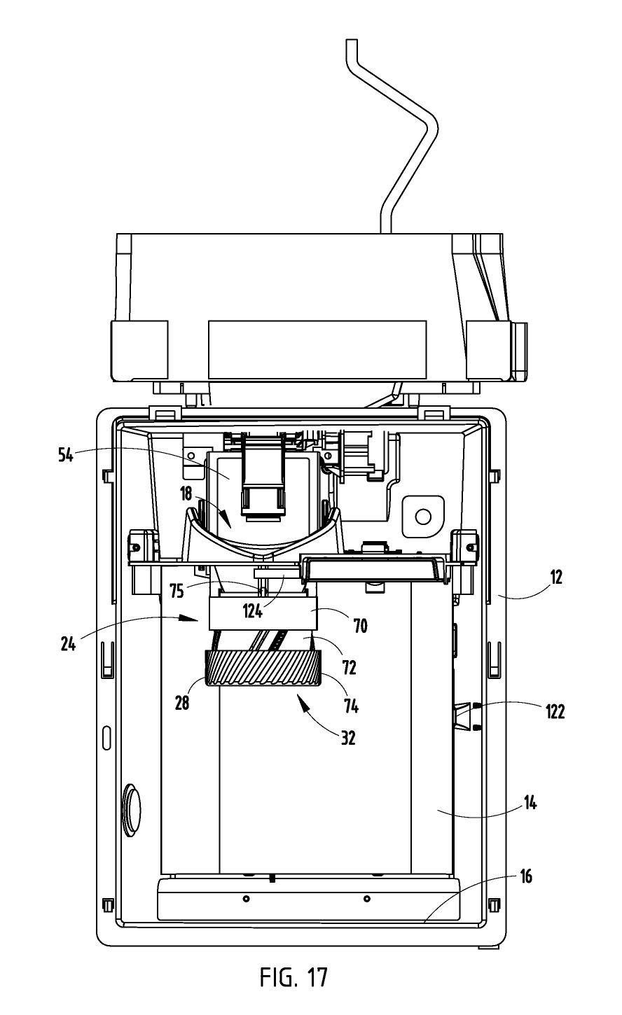

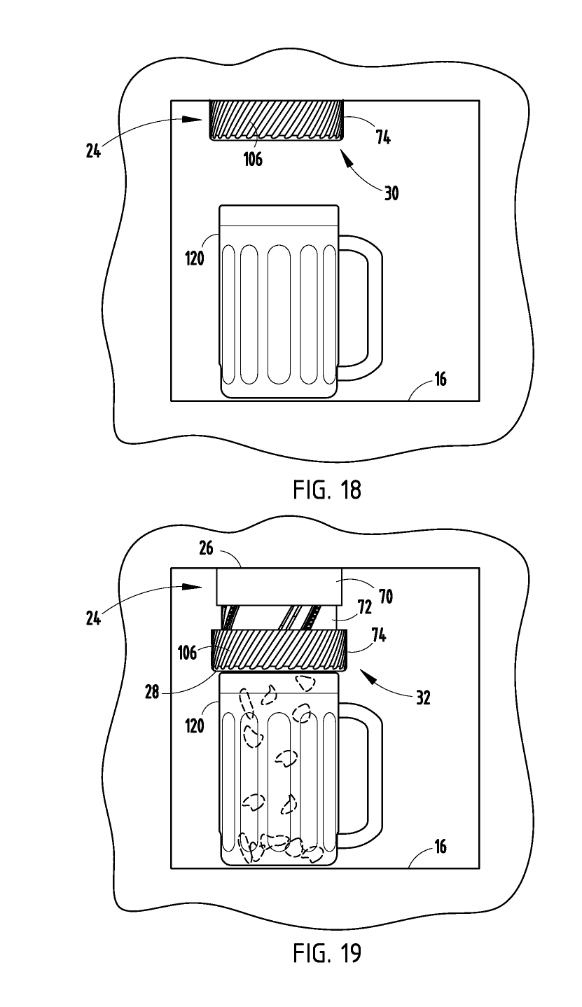

Referring now to FIGS. 18 and 19, when a user places a cup 120 below the ice dispensing passage and lowers the variable funnel 24, such that the distance between the distal end 28 of the variable funnel 24 and the top of the cup 120 is minimized, the likelihood of splashing is also minimized. It is contemplated that the variable funnel 24 may be secured to a motor (not shown) that operably raises and lowers the variable funnel 24 to a position adjacent to or abutting the top of the cup 120. It is also contemplated that an infrared eye 122 (FIG. 17) or other detection device may be used to determine the total distance that the variable funnel should descend before stopping. In another embodiment, a pressure sensor 124 (FIG. 17) detects when the distal end of the variable funnel 24 contacts the top of the cup 120.

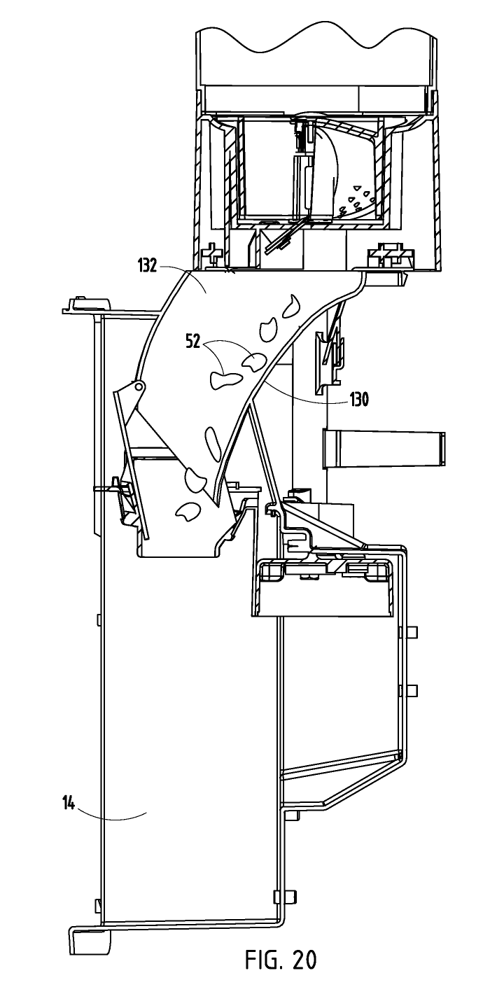

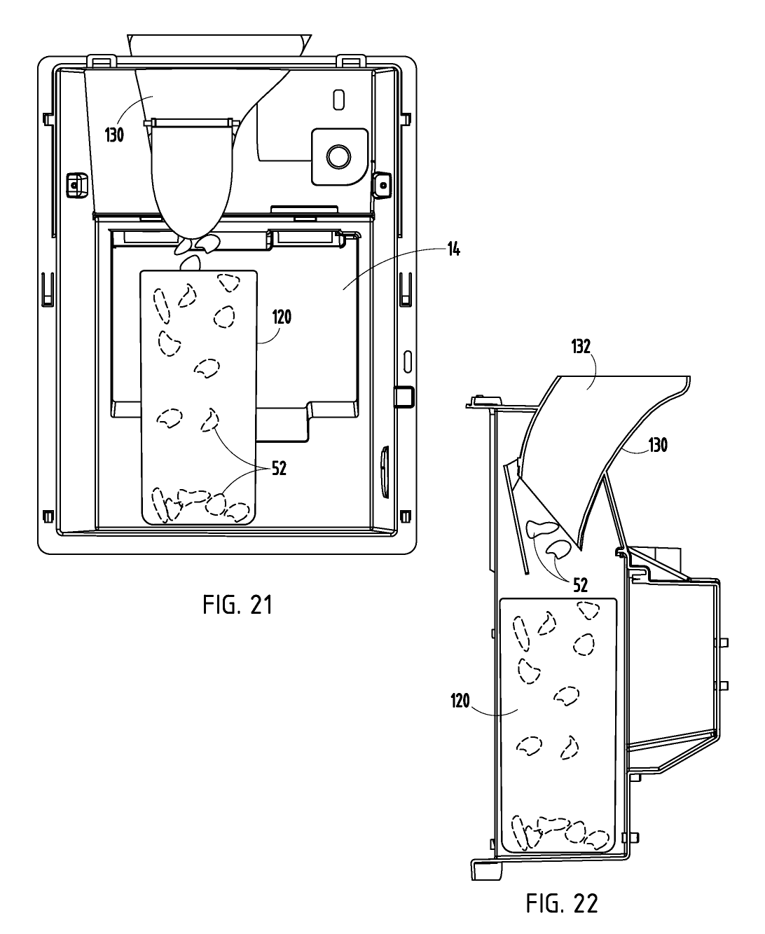

Referring now to the illustrated embodiment of FIGS. 20-22, an ice dispensing passage 130 that conveys ice 52 from the ice storage unit 58 to the fixed funnel 18 and includes a substantially vertical chute 132. The vertical chute 132 is convex outward and includes a large dispensing aperture for relaying ice 52 from the ice storage unit 58 to the fixed funnel 18. The ice dispensing passage 130 includes a substantially tubular and arcuate construction that minimizes tumbling of ice 52 as the ice 52 cascades down into the cup 120 of a user. Because of the minimized tumbling, the likelihood that ice 52 will break during dispensing is lessened. In addition, the vertical nature of the ice dispensing passage 130, along with the functionality of the variable funnel helps to ensure that dispensed ice 52 falls into the cup 120 and does not miss the cup 120.

The above description is considered that of the illustrated embodiments only. Modifications of the invention will occur to those skilled in the art and to those who make or use the invention. Therefore, it is understood that the embodiments shown in the drawings and described above is merely for illustrative purposes and not intended to limit the scope of the invention, which is defined by the following claims as interpreted according to the principles of patent law, including the Doctrine of Equivalents.

The invention claimed is:

1. An appliance dispenser comprising:
a housing including a receptacle support member and a fixed funnel;
an ice dispensing passage extending through the fixed funnel and operably connected with an ice bin; and
a variable funnel having a proximal end and a distal end, wherein the proximal end is adjacent the fixed funnel, and wherein the distal end is movable between a retracted position and an extended position.

2. The appliance dispenser of claim 1, wherein a portion of the distal end rotates relative to the proximal end as the distal end moves between the retracted position and the extended position.

3. The appliance dispenser of claim 1, wherein the variable funnel includes a plurality of distinct concentrically-aligned annular segments.

4. The appliance dispenser of claim 3, wherein the plurality of segments are threadably engaged and adapted to rotate relative to one another.

5. The appliance dispenser of claim 1, wherein the variable funnel is connected with a mechanical device operably linked with a controller, the mechanical device being adapted to move the distal end between the retracted position and the extended position.

6. The appliance dispenser of claim 5, wherein the mechanical device includes a pressure sensitive transmission adapted to sense an object in abutting contact with the distal end of the variable funnel.

7. The appliance dispenser of claim 3, wherein the plurality of distinct concentrically-aligned annular segments includes a first segment and a second segment, and wherein the inside diameter of the first segment is larger than the outside diameter of the second segment.

8. The appliance dispenser of claim 1, wherein the proximal end and distal end do not rotate relative to one another and are adapted for linear translation relative to one another.

9. An appliance comprising:
an ice bin;
a dispenser adjacent to the ice bin;
a fixed funnel extending from the dispenser;
an extendable funnel adjacent to the fixed funnel and adapted to be extended to a first position and retracted to a second position; and
an ice dispensing passage extending from the ice maker through the fixed funnel and extendable funnel, such that the ice dispensing passage lengthens when the extendable funnel moves from the first position to the second position.

10. The appliance of claim 9, wherein a portion of the distal end rotates relative to the proximal end as the distal end moves between the retracted position and the extended position.

11. The appliance of claim 9, wherein the variable funnel includes a plurality of distinct concentrically-aligned annular segments.

12. The appliance of claim 11, wherein the plurality of segments are threadably engaged and adapted to rotate relative to one another.

13. The appliance of claim 9, wherein the variable funnel is connected with a mechanical device operably linked with a controller, the mechanical device being adapted to move the distal end between the retracted position and the extended position.

14. The appliance of claim 13, wherein the mechanical device includes a pressure sensitive transmission adapted to sense an object in abutting contact with the distal end of the variable funnel.

15. The appliance of claim 11, wherein the plurality of distinct concentrically-aligned annular segments includes a first segment and a second segment, and wherein the inside diameter of the first segment is larger than the outside diameter of the second segment.

16. The appliance of claim 9, wherein the proximal end and distal end do not rotate relative to one another and are adapted for linear translation relative to one another.

17. A dispenser for use on an appliance comprising:
a housing defining a recess, the housing including a receptacle support member and a first funnel;
an ice dispensing passage extending through the first funnel and into operable connection with an ice bin; and
a second funnel including a distal end and operable between an extended position and a retracted position, wherein the distal end of the second funnel is closer to the first funnel when in the retracted position then when in the extended position.

18. The dispenser of claim 17, wherein the second funnel includes at least two annular rings having different inside diameters.

19. The dispenser of claim 18, wherein the annular rings are connected by a living hinge.

20. The dispenser of claim 17, further comprising:
a motor operably connected with the second funnel and adapted to translate the second funnel between the extended position and the retracted position.
